(19) United States
(12) Patent Application Publication
(10) Pub. No.: US 2002/0096629 A1
(43) Pub. Date: Jul. 25, 2002

(54) Fiber optic image mapping apparatus and method

(75) Inventor: James Korein, Chappaqua, NY (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(73) Assignee: Cyclovision Technologies, Inc.

(21) Appl. No.: 09/733,943

(22) Filed: Dec. 12, 2000

Related U.S. Application Data
(60) Provisional application No. 60/171,306, filed on Dec. 21, 1999.

(51) Int. Cl. H04N 1/04

(52) U.S. Cl. 250/227.11

(57) ABSTRACT

An apparatus for transforming the shape of an image in a way that utilizes substantially all the available pixels for both the image generated and the sensor to which the image is projected, is disclosed. Also disclosed is an apparatus and method to reduce or eliminate substantially any blurring associated with a non-planar focal plane associated with an image generated from a curved mirror, particularly when some portions of the image are focused on the plane of the sensor and other portions are blurred. Loss of image resolution is eliminated, thereby achieving desired fiber optic image mapping, by the present invention for coherent and incoherent fiber optic cables.

### PRIORITY

The present application claims priority to the provisional patent application Serial No. 60/171,306 entitled, “Fiber Optic Image Mapping Apparatus and Method”, filed Dec. 21, 1999.

### FIELD OF INVENTION

The present invention generally relates to electrical output optical sensors. More particularly, the present invention relates to optical fiber cables for conveying information to such sensors.

### BACKGROUND OF INVENTION

In many imaging applications, including omni-directional imaging, an image is obtained through an optical system comprising lenses and/or mirrors, and then projected onto a sensor, typically a planar charged-coupled device (“CCD”) image sensor or a CMOS image sensor.

Generally, the shape of the image is very different than that of the CCD sensor. CCDs and similar sensors, for example, are typically rectangular, with an aspect ratio of 4 to 3. New sensors for digital high definition television (HDTV) may have an aspect ratio of 16 to 9.

In omni-directional imaging, the image is circular. Typically, one inscribes the circular image in the rectangular sensor, wasting the remaining pixels. In the case of a 4 by 3 rectangle, about 46% of the pixels are wasted. In a 16 by 9 rectangle, 65% are wasted.

The following prior patents represent the state of the image sensing technology art, and are all hereby incorporated by reference.

U.S. Pat. No. 4,935,630 to Merchant discloses a wide field of view imaging system for use in Missile Warning Systems. He uses a lens-sphere optical system with optical filtering to minimize spot-size, thereby improving resolution. He describes the use of a concave to flat, coherent (that is, non-randomly arranged bundled optical fibers) optic converter to carry an image from a concave, spherical surface to an optical filter and from there to an infrared detector. He does not disclose, teach, or suggest reshaping the image to fit a sensor surface by varying the cross-sectional shape of a fiber bundle. Indeed, Merchant discloses only a circular or annular geometry from end to end, and it appears that bundle tapers away from the end in contact with a lens-sphere. The entire disclosure of Merchant is incorporated by reference herein.

U.S. Pat. No. 4,978,195 to Takano et al. discloses interposition of transparent media between an image sensor and a fiber bundle conveying a CRT image. This patent covers the use of transparent conductors. Transparent non-conductors, such as epoxy, may be used to reduce diffraction artifacts between fiber bundle and sensor. The entire disclosure of this patent is incorporated by reference herein.

U.S. Patent Nos. 5,266,828 and 5,448,055 to Nakamura et al. has used partially masked fiber optic substrates with CCDs to improve CCD manufacturing and reduce optical artifacts. The entire disclosures of these patents are incorporated by reference herein.

U.S. Pat. No. 4,323,925 to Abell et al. has used tapered, coherent fiber optic bundles that split into branches to split an image over multiple image sensors. The bias toward tapered fiber bundles is evident throughout the disclosure. The entire disclosure of this patent is incorporated by reference herein.

U.S. Pat. No. 4,549,175 to Rokunohe et al. provides mapping of the positions of the cables in an incoherent fiber optic bundle, in order to reconstruct coherence. There is no disclosure, teaching, or suggestion regarding the use of different geometries or cross sections between the two ends. The entire disclosure of this patent is incorporated by reference herein.

U.S. Pat. No. 4,674,834 to Margolin uses an incoherent (randomly arranged) optical fiber bundle useful in graphical input or output devices, such as copiers. Specifically one end of the bundle is affixed to a photo-sensor array, exemplified by RAM. Thus, the addresses of the optical fibers are obtained by shining light into consecutive fibers at one end and noting which fiber illuminates a sensor on a photosensitive random access memory at the other end. The other end, in his embodiment, interfaces with a linear optical array. Margolin fails to disclose, teach, or suggest a first geometric shape other than a linear geometry, i.e., a straight line. The entire disclosure of this patent is incorporated by reference herein.

U.S. Pat. No. 5,159,455 to Cox et al. has used the branching bundle concept as the basis of the design of a high resolution video camera using multiple, low-resolution image sensors. The sensor arrays are either multiple single port integrated circuit (IC) sensor arrays, such as CCD arrays or multi-port (IC) arrays. Cox et al. discloses a split embodiment in which the cross sectional geometric shape at one end is either the same as or different from the cross sectional shape at the opposite end. The fiber bundles are always tapered, however, where the cross-sectional geometric shapes differ from end to end. The entire disclosure of this patent is incorporated by reference herein.

U.S. Pat. No. 5,121,458 to Nilsson et al. discloses a pre-terminated fiber optic cable with a trunk cable having a predetermined length and having multiple drop cables spliced to the trunk cable at various branch points. The entire disclosure of this patent is incorporated by reference herein.

U.S. Pat. No. 4,878,046 to Smith discloses a heads-up, helmet mounted display system, which utilizes an optical fiber bundle for transmitting images from an image reducer to an image expander. The entire disclosure of this patent is incorporated by reference herein.

U.S. Pat. No. 5,311,611 to Migliaccio discloses an apparatus in which a plano-convex imaging ball lens is in contact with the ends of a plano-concave fiber optic faceplate. The concave surface of the faceplate is optically coupled to the convex surface of the second lens element facing the object side of the lens such that it is optically immersed with the fiber optic faceplate. Further, a curved focal plane formed at the convex surface of the second lens element is mapped into a flat focal plane at the planar surface of the fiber optic faceplate allegedly defining a clear image essentially free from coma and astigmatic aberration and allegedly displaying a minimum of chromatic aberration. The entire disclosure of this patent is incorporated by reference herein.

Omni-directional optical systems are typically achieved using either wide-angle lenses, or lenses in conjunction with curved mirrors. In the latter case, the system of lens(es) projects an image of the mirror onto a sensor, such as a CCD sensor. However, since the mirror is curved, the image is not entirely focused in a single plane. Consequently, when some portions of the image are focused on the plane of the sensor, other portions are blurred. This is sometimes addressed by using a field flattening lens to reduce the curvature of the focused image, thereby reducing blurring.

Therefore, there is a need for a system and method for transforming the shape of an image in a way that utilize substantially all the available pixels for both the image generated and the sensor to which the image is projected. There is also a need for such a system and method to reduce or eliminate substantially any blurring associated with a non-planar focal plane associated with an image generated from a curved mirror.

### SUMMARY OF THE INVENTION

The present invention satisfies, to a great extent, the foregoing and other needs not currently satisfied by existing systems and methods. This result is achieved, in an exemplary embodiment, by a fiber optic image mapping system comprising a fiber optic cable having a configuration that aligns to individual fibers with individual pixels or sensor elements. More specifically, the fibers in a fiber bundle are aligned at the end to interface with an image sensor, such that each fiber terminates directly on or over a specific element of the sensor array.

In another aspect of the invention a rectangular arrangement of the fibers is provided, wherein the fibers are arranged in a rectangular grid in which the rectangular grid corresponds to the rectangular grid on which the elements of a CCD sensor chip are located. The rectangular end of the fiber is placed, for example, directly in contact with the CCD sensor. Consequently, the entire image is mapped in a one-to-one fashion onto the entire CCD.

In this aspect the fiber bundles are produced by a device that extrudes sections of fiber. Each section is extruded through a screen whose pitch is the same as that of a CCD sensor, and then through a circular band, which ultimately surrounds all fibers at the opposite end. After each fiber section is extruded, it is cut, and an indexing device moves the screen to the next desired position. Once all fibers have been inserted, the band is tightened to constrain the fibers at the far end.

In another aspect of the invention a device to determine the mapping achieved by the fiber bundle is provided. To use the data recorded by the sensor when, for example, the image is mapped in a one-to-one fashion onto the entire CCD sensor, it is necessary to invert the mapping achieved by the fiber bundle. Second, it is necessary to first determine what the mapping is. Once the mapping is known, it may be encoded in a lookup table, which is preferably indexed by sensor coordinates, and in which each element contains image coordinates.

In another aspect of the invention, particularly when some portions of the image are focused on the plane of the sensor and other portions are blurred, an alternative to use of a field flattening lens is provided. More specifically, a fiber optic bundle is inserted between the lens system and the sensor. At or near the end of the bundle, closer to the lens system, is curved. In other words, the fibers are of differing lengths. And because the image of the mirror is not focused in a plane, the locus of points at which the image is focused forms a non-planar surface, typically a quadric surface. This may be called the focal surface. The shape of the near end of the bundle is designed to match the focal surface. The far end of the bundle is planar, impinging directly on the sensor. This configuration effectively eliminates the problem of non-planar focus.

In another aspect of the invention a method of conveying an image without blur is provided. The method comprises the steps of (a) generating an image comprising individual pixels, the generated image having a first geometric shape and having a first surface area; and (b) conveying the generated image through a non-tapered bundle of optical fibers comprising a plurality of individual optical fibers, where the non-tapered bundle has a first end and a second end, in which (i) the first end is adapted to conform substantially with the first geometric shape of the generated image and to cover at least a portion of the first surface area of the generated image, and (ii) the second end is adapted to conform to a second geometric shape that is other than the first geometric shape of the generated image but which has a second surface area corresponding substantially to that portion of the first surface area covered by the first end, provided that the first geometric shape does not include a straight line and, preferably, that the cross sectional geometry of the first end differs from that of the second end.

The present invention also provides an apparatus for carrying out this method. Hence, in a particular embodiment of the invention a “coherent” fiber optic cable is described herein with, for example, the added feature that the fibers in the fiber bundle are aligned, at the end of the interfaces with the image sensor, so that each fiber terminates directly on or over a specific element of the sensor array. In other words, each fiber, if extended, would penetrate one predetermined element of the sensor array. This eliminates the possible loss of resolution which would arise from an uncertain relationship between the ends of each fiber and the elements of the sensor array in an “incoherent” fiber optic bundle.

In another embodiment of the invention an apparatus for conveying an image to a sensor is provided which comprises a fiber optic cable comprised of individual optical fibers, the cable having a first end with a first shape and a first area, a second end having a second shape other than the first shape and a second area, and a sensor comprised of individual sensor elements, the sensor having about the same shape and about the same area as the second end, the number of individual optical fibers in the cable being about the same as the number of sensor elements in the sensor.

Yet another apparatus is described for conveying a non-planar image to a planar sensor. The apparatus comprises a lens or mirror that projects a non-planar image having a focal plane away from the surface of the lens or mirror; an optic fiber cable comprised of individual optical fibers, the cable having a first end and a second end, the first end comprised of the first ends of individual optical fibers, each fiber arrayed away from the surface of the lens or mirror and in the focal plane of the lens or mirror, the second end comprised of a planar array of the second ends of the individual optical fibers; and a planar sensor in communication with the second end of the optic fiber cable.

In yet another embodiment of the invention an apparatus for conveying a non-planar image to a planar sensor is provided. The apparatus comprises a lens or mirror that projects a non-planar image having a focal plane away from the surface of the lens or mirror; an optic fiber cable comprised of individual optical fibers, the cable having a non-planar first end and a planar second end, the first end having substantially the same shape as the non-planar image projected away from the lens or mirror and a first area, the first end comprised of the first ends of individual optical fibers, each fiber arrayed away from the surface of the lens or mirror and in the focal plane of the lens or mirror, the second end comprised of a planar array of the second ends of the individual optic fibers, the second end having a shape and a second area; and a planar sensor comprised of sensor elements in communication with the second end of the optic fiber cable, the sensor having about the same shape and substantially the same area as the second end, the number of individual optical fibers in the cable being substantially the same as the number of sensor elements in the sensor.

In a method for manufacture of an optic fiber cable for use in communication with a sensor, which cable comprises individual sensor elements, the sensor having a shape and area, the optical fiber cable comprising individual optical fibers, each individual optical fiber having two ends, the steps comprising: (a) obtaining substantially as many individual optical fibers as individual sensor elements in the sensor; (b) affixing the individual optical fibers into a optic fiber cable having a end of substantially the same shape and area as the sensor, with substantially each optical fiber aligned with one sensor element when the optical fiber is in communication with the sensor.

Other objects of the invention will become apparent to one of ordinary skill upon consideration of the balance of this disclosure, including the accompanying claims.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE EMBODIMENTS

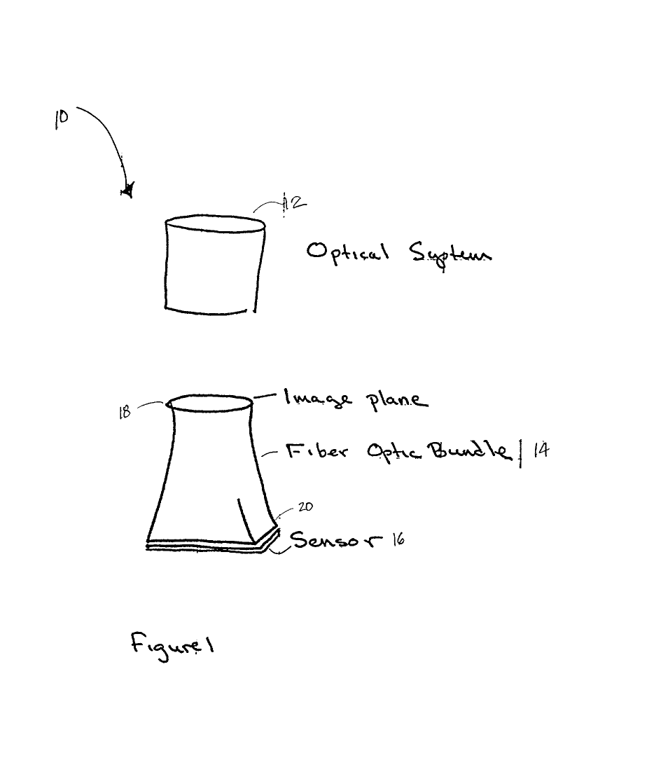

FIG. 1 illustrates an apparatus for transforming the shape of an image, in accordance with a preferred embodiment.

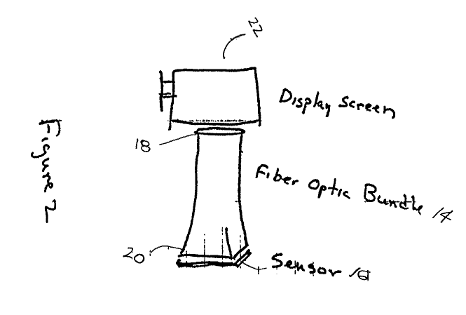

FIG. 2 illustrates the present invention employed with a mapping device, such as a display tube.

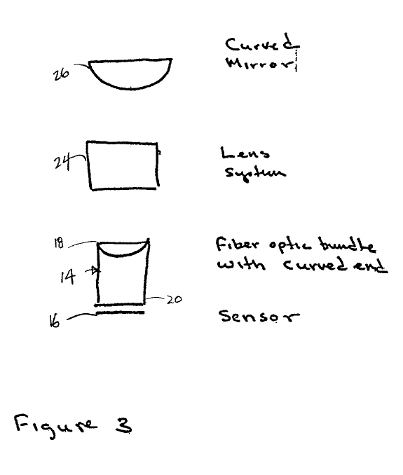

FIG. 3 illustrates a cross-sectional view of an apparatus for eliminating blurring according to another aspect of the present invention.

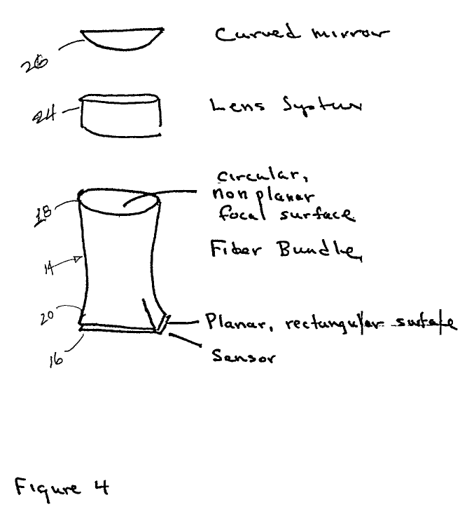

FIG. 4 illustrates a perspective view of an apparatus for eliminating blurring according to another aspect of the present invention.

### DESCRIPTION OF PREFERRED EMBODIMENTS

One embodiment of the present invention is shown in FIG. 1, which is an apparatus for transforming the shape of an image. The apparatus 10 comprises an optical system 12, a fiber optic bundle 14, and a sensor 16, such as a planar charged-coupled device (CCD) sensor. Preferably, the optical system 12 may be an omni-directional imaging system. Alternatively, the optical system may comprise one or more lens or mirrors. Also, the sensor, which may be configured as a sensor array, may comprise a CMOS sensor or a photographic plate.

The first end 18 of the fiber optic bundle 14 is preferably shaped in the form of the image. The shape of the second end 20 of the fiber optic bundle 14 more closely approximates the shape of an image sensor 16. Preferably, as is the case in this embodiment, the shape of the image may be a circular disk, or a circular disk truncated by one or more chords.

In a preferred embodiment, the shape of the image sensor 16 is generally rectangular. The corresponding end 20 of the bundle 14 is preferably rectangular. Alternatively and optionally, the corresponding end 20 may be elliptical. This would permit more pixels of a rectangular sensor to be used than those of a circle.

The cable comprising the fiber optic bundle 14 is achieved by bundling one or more optical fibers together in order to transmit an optical image from one end 18 of the bundle to the other end 20 by projecting the optical image with the aid of an optical system 12, for example, on the front end 18 of the bundle, and allowing the image to be transferred through the bundle 14 and formed in the rear end 20 of the bundle 14.

The apparatus of the present invention, as described above, overcomes conventional practice of inscribing a circular image onto the rectangle of the CCD sensor, because the optical system 12 is designed to generate a circular image with the same area as the CCD sensor 16. Hence, instead of projecting this image directly onto the sensor 16, it is projected onto the end 20 of the fiber optic bundle 14.

The fiber optic bundle 14 is fabricated so that one end has a circular cross-section, and the other end has a rectangular cross-section congruent with the sensor 16. In a preferred embodiment, the rectangular end is placed directly in contact with the sensor 16. Thus, the entire image is mapped in a one-to-one fashion onto the entire sensor 16.

Alternatively and optionally, branching the image onto multiple sensors is also contemplated by the present invention. Alternatively and optionally, changing the cross-sectional geometry of each fiber from one end of the bundle 14 to the other. In addition, a coherent bundle (i.e. an arrangement of fibers wherein the relative geometric positions of the fibers do not differ at the opposite ends of a fiber bundle) to directly produce a panoramic image can be provided, which can optionally use either tapered or diverging fibers.

To use the data recorded by sensor 16 in the arrangement of FIG. 1, it is necessary to invert the mapping that is achieved by the fiber optic bundle 14. Such a mapping device is shown in FIG. 2 where the fiber optic bundle 14 is mounted with a display screen 22 at its rounded end 18, and a sensor 16 at its rectangular end 20. Pixels of the display screen 22 are illuminated one at a time, and the resulting illuminated pixels in the sensor 16 are recorded. A mapping is thereby established, employing software programs and/or one or more lookup tables, for inverting the mapping performed by the bundle 14.

Once the mapping is known, it may be encoded in a lookup table, which is indexed by sensor coordinates, and in which each element contains image coordinates.

As an alternative to illuminating one pixel at a time, multiple pixels may be illuminated at once to save time, as long as an unambiguous mapping can be established. Optimal techniques such as Grey Codes have been established.

Referring now to FIGS. 3 and 4, in another embodiment of the present invention, a fiber optic bundle 14 is inserted between a lens system 24 and a sensor 16, with the end 18 of the bundle 14 closer to the lens system 24 (i.e. the near end 18) being curved. In other words, the fibers are of different lengths.

Since the mirror 26 is curved, a projection of an image from the lens system 24 is not focused in a single plane. Consequently, if not for the curvature of the near end 18 of the fiber bundle 14, when some portions of the image are focused on the plane of the sensor 16 other portions are blurred. Hence, the locus of points at which the image is focused forms a non-planar surface, typically a quadric surface. The locus of points can be termed the focal surface.

In order to reduce blurring due to non-planar focus, in accordance with this preferred embodiment, the shape of the near end 18 of the bundle 14 is designed to match the focal surface; that is, by being similarly curved. The far end 20 of the bundle 14 is planar, impinging directly on the sensor 16. This configuration effectively eliminates the problem of non-planar focus.

The fiber optic bundle 14 is configured with a near end 18 having a circular cross-section, but which cross-section is non-planar and corresponds to the focal surface produced by imaging a curved mirror 26. Optionally, the curved surface 18 of the fiber bundle 14 may be spherical, parabolic, hyperbolic, ellipsoidal or conic, corresponding to the shape of the image produced by the curved mirror 26 and lens 24. Moreover, the curved surface 18 may be concave or convex.

The far end 20 of the bundle 14 is planar with a rectangular cross-section corresponding to the sensor 16. This configuration solves the blurring problem by using all of the pixels in the sensor effectively.

The above description and drawings are only illustrative of preferred embodiments that achieve the objects, features and advantages of the present invention, and it is not intended that the present invention be limited thereto. Any modification of the present invention that comes within the spirit and scope of the following claims is considered to be part of the present invention.

What is claimed is:

1. An apparatus for conveying an image to a sensor, said apparatus comprising:
(a) a fiber optic cable comprised of individual optical fibers, said cable having a first end with a first shape and a first area, and a second end having a second shape other than said first shape and a second area;
(b) a sensor comprised of individual sensor elements, said sensor having substantially the same shape and substantially the same area as said second end without inscribing a circular image onto the shape of said sensor; and
(c) an optical system that produces an image.

2. The apparatus according to claim 1, wherein each individual optical fiber is assigned to one or more individual pixels.

3. The apparatus according to claim 1, wherein each individual pixel is assigned to one or more individual optical fibers.

4. The apparatus according to claim 1, wherein each individual optical fiber projects an image onto one or more individual sensor elements.

5. The apparatus according to claim 1, wherein one or more individual optical fibers project an image onto an individual sensor element.

6. The apparatus according to claim 1, wherein said first shape is in the form of said image.

7. The apparatus according to claim 6, wherein said first shape is configured as having at least one of a substantially circular cross-section, substantially elliptical cross-section or any subset thereof.

8. The apparatus according to claim 1, wherein said second shape is in the form of an image sensor.

9. The apparatus according to claim 8, wherein said second shape is configured as having at least one of a substantially rectangular and square cross-section.

10. The apparatus according to claim 1, wherein said first end is adapted to conform to a non-planar surface.

11. The apparatus according to claim 10, wherein said non-planar surface comprises a quadric surface.

12. The apparatus according to claim 10, wherein said non-planar surface comprises a spherical surface.

13. The apparatus according to claim 12, wherein said spherical surface is concave.

14. The apparatus according to claim 10, wherein said non-planar surface comprises a parabolic surface.

15. The apparatus according to claim 14, wherein said parabolic surface is concave.

16. The apparatus according to claim 10, wherein said non-planar surface comprises a hyperbolic surface.

17. The apparatus according to claim 10, wherein said non-planar surface comprises a convex surface.

18. The apparatus according to claim 1, wherein said second end is adapted to conform to a substantially planar surface.

19. The apparatus according to claim 1, wherein said sensor comprises at least one of a CCD sensor, a CMOS sensor and a photographic plate.

20. The apparatus according to claim 1, wherein said optical system comprises one or more lens, one or more mirrors, or one or more lens and mirrors.

21. The apparatus according to claim 20, wherein said at least one or more mirrors is curved.

22. The apparatus according to claim 20, wherein said at least one or more mirrors is a convex parabolic mirror.

23. The apparatus according to claim 20, wherein said at least one or more mirrors is a convex or concave hyperbolic mirror.

24. The apparatus according to claim 20, wherein said at least one or more mirrors is a convex or concave spherical mirror.

25. The apparatus according to claim 20, wherein said at least one or more mirrors is an ellipsoidal mirror.

26. The apparatus according to claim 20, wherein said at least one or more mirrors is a convex or concave conical mirror.

27. The apparatus according to claim 1, wherein said optical system comprises an omni-directional imaging system.

28. The apparatus according to claim 1, wherein said optical system comprises a display screen mounted at said first end.

29. The apparatus according to claim 1, further comprising a computer readable set of instructions for inverting mapped images conveyed through said fiber optic cable.

30. The apparatus according to claim 29, wherein said instructions employ one or more lookup tables.

31. The apparatus according to claim 1, wherein a bundle of said individual optical fibers forms a coherent bundle.

32. The apparatus according to claim 1, wherein a bundle of said individual optical fibers forms an incoherent bundle.

33. The apparatus according to claim 1, wherein the fibers are arranged in a rectangular grid in which the rectangular grid corresponds to a rectangular grid on which elements of a sensor chip are located.

34. The apparatus according to claim 33, wherein each rectangular end of each fiber is placed directly in contact with a sensor or sensor element.

35. A method of conveying an image without blur, said method comprising the steps of:
(a) generating an image comprising individual pixels, each generated image having a first geometric shape and having a first surface area; and
(b) conveying said generated image through a non-tapered bundle of optical fibers comprising a plurality of individual optical fibers, said non-tapered bundle having a first end and a second end, in which (i) said first end is adapted to conform substantially with said first geometric shape of said generated image and to cover at least a portion of said first surface area of said generated image, and (ii) said second end is adapted to conform to a second geometric shape that is other than said first geometric shape of said generated image but which has a second surface area corresponding substantially to that portion of said first surface area covered by said first end, provided that said first geometric shape does not include a straight line and that a cross-sectional geometry of said first end differs from that of said second end.

36. The method of claim 35, further comprising the step of projecting each conveyed image onto a sensor array comprising a plurality of individual sensor elements.

37. The method of claim 35, in which the fiber bundle is coherent.

38. The method of claim 35, in which the fiber bundle is incoherent.

39. The method of claim 36, further comprising the step of eliminating loss of image resolution in a fiber optic bundle.

40. An apparatus for conveying a non-planar image to a planar sensor, said apparatus comprising:
(a) a lens or mirror that projects a non-planar image having a focal plane away from a surface of the lens or mirror;
(b) an optical fiber cable comprised of individual optical fibers, the cable having a first end and a second, said first end including first ends of said individual optical fibers, each fiber arrayed away from a surface of said lens or mirror and in the focal plane of said lens or mirror, the second end of said cable comprising a planar array of second ends of said individual optical fibers; and
(c) a planar sensor in communication with said second end of said optical fiber cable.

41. An apparatus for conveying a non-planar image to a planar sensor, said apparatus comprising:
(a) a lens or mirror that projects a non-planar image having a focal plane away from a surface of the lens or mirror;
(b) an optical fiber cable comprised of individual optical fibers, the cable having a non-planar first end and a planar second, said first end having a first area and a shape substantially identical to a shape of a non-planar image projected away from the lens or mirror, said first end including first ends of said individual optical fibers, each fiber arrayed away from a surface of said lens or mirror and in the focal plane of said lens or mirror, the second end of said cable comprising a planar array of second ends of said individual optical fibers, the second end having a shape and a second area; and
(c) a planar sensor comprised of sensor elements in communication with the second end of said optical fiber cable, the sensor having a shape and area substantially identical to a shape and area of said second end.

42. In a method of manufacture of an optical fiber cable for use in communication with a sensor, which cable comprises individual sensor elements, the sensor having a shape and an area, each individual optical fiber having two ends, the method comprising the steps of:
(a) obtaining substantially as many individual optical fibers as individual sensor elements in the sensor;
(b) arranging each individual optical fiber into an optical fiber cable forming a bundle, said cable having an end that has a shape and area substantially identical to a shape and area of said sensor, where each optical fiber is substantially aligned with at least one sensor element when the optical fiber is in communication with said sensor.
